(19) United States
(12) Patent Application Publication
(10) Pub. No.: US 2019/0197526 A1
(43) Pub. Date: Jun. 27, 2019

(54) CASHLESS RETAIL WALLET WITH JUST-IN-TIME FUNDING FROM CASHLESS WAGERING WALLET

(71) Applicant: IGT, Las Vegas, NV (US)

(72) Inventors: Kevin Higgins, Reno, NV (US); Jeffrey Shepherd, Reno, NV (US)

(21) Appl. No.: 15/852,602

(22) Filed: Dec. 22, 2017

(51) Int. Cl. G06Q 20/36; G06Q 50/34; G07F 17/32

(52) U.S. Cl. CPC G06Q 20/36; G07F 17/32; G06Q 50/34

(57) ABSTRACT

Cashless financial accounts and wallets, and in particular to a cashless retail wallet with just-in-time funding from a cashless wagering wallet, are disclosed. In this regard, in one example, a server may receive a request to withdraw an amount of currency from a cashless retail wallet or other financial account as part of a purchase transaction, which is subject to a set of regulatory rules. In response to receiving the request, an amount of currency is transferred from a cashless wagering wallet or other financial account that is subject to a different set of regulatory rules into the cashless retail wallet, so that the cashless retail wallet has sufficient funds to complete the requested withdrawal. The funds are then withdrawn from the cashless retail wallet to complete the purchase transaction.

### COPYRIGHT NOTICE

A portion of the disclosure of this patent document contains or may contain material that is subject to copyright protection. The copyright owner has no objection to the photocopy reproduction by anyone of the patent document or the patent disclosure in exactly the form it appears in the Patent and Trademark Office patent file or records, but otherwise reserves all copyright rights whatsoever.

### FIELD

Embodiments relate to cashless financial accounts and wallets, and in particular to a cashless retail wallet with just-in-time funding from a cashless wagering wallet, and related methods and systems.

### BACKGROUND

Many gaming enterprises, such as casinos, employ cashless financial accounts as a way of managing wagering activity by players. One example of a financial account used for managing wagering activity is a cashless wagering wallet, such as the EZPay™ system used by IGT®, which is described in detail in U.S. Pat. No. 6,852,031.

This type of account may be associated with a card and/or mobile device, and allows a player at a casino to place wagers and collect winnings without using cash. These types of gaming wallets have some drawbacks as well, however. For example, cashless wagering wallets are highly regulated, signing up for a cashless wagering wallet can be relatively difficult, and may involve many steps, and may also require that the player provide signatures and documentation during the sign-up process.

Many gaming enterprises also offer additional services, such as retail and other services, which are not gaming-related. In many casinos, for example, non-gaming revenue may account for 50% or more of the total revenue for the casino. For these non-gaming services, it is possible to offer a different type of cashless wallet in the form of a retail wallet, which is subject to a different set of regulations that are generally less restrictive than the regulations associated with cashless wagering wallets. In particular, the sign-up process for a cashless retail wallet may be significantly less time-consuming and intrusive. As a result, use of a cashless retail wallet may be widespread among customers who might not otherwise go through the additional steps required to sign up for a cashless wagering wallet. Meanwhile, a customer that has a pre-existing cashless wagering wallets may be interested in using funds from the cashless wagering wallet to fund retail purchases using his cashless retail wallet, but one drawback to many cashless retail wallets is that regulations may prevent directly withdrawing or transferring funds from the cashless retail wallet after those funds are deposited. Instead, funds in cashless retail wallet may only be used for purchasing goods and services. Thus, because of these conflicting regulatory schemes for the different types of accounts, it is difficult to provide a single financial account that can use funds for both gaming and non-gaming activity transparently and efficiently.

### SUMMARY

Embodiments relate to cashless financial accounts and wallets, and in particular to a cashless retail wallet with just-in-time funding from a cashless wagering wallet, and related methods and systems. In this regard, in one embodiment, a server may receive a request to withdraw an amount of currency from a cashless retail wallet or other financial account as part of a purchase transaction, which is subject to a set of regulatory rules. In response to receiving the request, an amount of currency is transferred from a cashless wagering wallet or other financial account that is subject to a different set of regulatory rules into the cashless retail wallet, so that the cashless retail wallet has sufficient funds to complete the requested withdrawal. The funds are then withdrawn from the cashless retail wallet to complete the purchase transaction.

One advantage of this arrangement is that a cashless wagering wallet and a cashless retail wallet can be associated with a common resort wallet. The resort wallet can be used for gaming activity, in which case funds are withdrawn and deposited directly from the cashless wagering wallet, and for retail activity. For retail activity, the cashless retail wallet may be maintained at a low or zero-balance, and funded on a just-in-time basis from the cashless wagering wallet. When a user attempts to purchase a retail or service item using the resort wallet, the request on the cashless retail wallet causes sufficient funds to be transferred from the cashless wagering wallet into the cashless retail wallet to cover the request, thereby enabling the use of cashless wagering funds to be used for cashless retail wallet purchases. Because it may not be possible to withdraw funds from the cashless retail wallet directly, only the funds sufficient to cover the request are transferred into the cashless retail wallet, so that the ending balance for the cashless retail wallet remains at a low or zero balance after the purchase is complete. In this manner, a single resort wallet can be used to transparently provide access to a user's cashless wagering wallet and cashless retail wallet without requiring the user to separately track two different cashless wallet accounts, and while also respecting some of the pre-existing regulatory rules surrounding cashless retail wallets that exist in the United States and other jurisdictions.

According to an embodiment, a method comprises receiving, at a server comprising a processing device, a request to withdraw a first amount of currency from a first financial account as part of a purchase transaction, wherein the first financial account is a retail account that is subject to a first set of regulatory rules. The method further comprises, in response to receiving the request, automatically transferring a second amount of currency from a second financial account to the first financial account, wherein the second financial account is a cashless wagering account that is subject to a second set of regulatory rules. The method further comprises withdrawing the first amount of currency from the first financial account as part of the purchase transaction.

According to another embodiment, automatically transferring the second amount of currency from a second financial account to the first financial account comprises in response to receiving the request to withdraw the first amount of currency from the first financial account, determining that the first financial account has a balance below the first amount of currency, and, in response to determining that the first financial account has a balance below the first amount of currency, transferring the second amount of currency from the second financial account to the first financial account so that the balance of the first financial account is above the first amount of currency.

According to another embodiment, automatically transferring the second amount of currency comprises selecting the second amount of currency so that transferring the second amount of currency to the first financial account and withdrawing the first amount of currency from the first financial account will result in the balance of the first financial account being no greater than a predetermined threshold amount.

According to another embodiment, the predetermined threshold amount is zero.

According to another embodiment, the method further comprises displaying a combined balance to a user, wherein the combined balance is equal to at least a sum of the balance of the first financial account and the balance of the second financial account.

According to another embodiment, displaying the combined balance to the user comprises concealing the balance of the first financial account and the balance of the second financial account from the user.

According to another embodiment, the method further comprises, prior to receiving the request to withdraw the first amount of currency from the first financial account, receiving a request to withdraw the first amount of currency from a third financial account as part of the purchase transaction, wherein the third financial account is a retail account that is subject to the first set of regulatory rules. The method further comprises determining that transferring the second amount of currency from the second financial account to the third financial account would violate at least one regulatory rule of the first set of regulatory rules. The method further comprises denying the request to withdraw the first amount of currency from the third financial account.

According to another embodiment, the method further comprises, prior to receiving the request to withdraw the first amount of currency from the first financial account, automatically creating the first financial account in response to determining that transferring the second amount of currency from the second financial account to the third financial account would violate at least one regulatory rule of the first set of regulatory rules.

According to another embodiment, determining that transferring the second amount of currency from the second financial account to the third financial account would violate at least one regulatory rule of the first set of regulatory rules comprises determining that transferring the second amount of currency from the second financial account to the third financial account would exceed a predetermined number of transfers for the third financial account.

According to another embodiment, the method further comprises receiving, at a server comprising a processing device, a request to deposit a first amount of currency to a first financial account as part of a reversal of the purchase transaction, and, in response to receiving the request, automatically transferring the first amount of currency to a second financial account.

According to another embodiment, automatically transferring the first amount of currency to the second financial account comprises determining that the previous purchase transaction included transferring the second amount of currency from the second financial account to the first financial account, and transferring the first amount of currency to the second financial account.

According to another embodiment, a method comprises receiving, at a server comprising a processing device, a request to withdraw a first amount of currency from a first financial account as part of a purchase transaction. The method further comprises, in response to receiving the request, determining that the first financial account has a balance below the first amount of currency. The method further comprises determining that transferring the second amount of currency to the first financial account would exceed a predetermined transfer limit for the first financial account. The method further comprises, in response to determining that transferring the second amount of currency to the first financial account would violate a predetermined rule for the first financial account, automatically transferring a second amount of currency from a second financial account to a third financial account so that the balance of the third financial account is above the first amount of currency. The method further comprises withdrawing the first amount of currency from the third financial account as part of the purchase transaction.

According to another embodiment, the method further comprises, in response to determining that transferring the second amount of currency to the first financial account would violate a predetermined rule for the first financial account, automatically creating a third financial account.

According to another embodiment, determining that transferring the second amount of currency from the second financial account to the first financial account would violate the predetermined rule for the first financial account comprises determining that transferring the second amount of currency from the second financial account to the first financial account would exceed a predetermined number of transfers for the first financial account.

According to another embodiment, the first financial account and the third financial account are retail accounts subject to a first set of regulatory rules.

According to another embodiment, the second account is a cashless wagering account that is subject to a second set of regulatory rules different from the first set of regulatory rules.

According to another embodiment, a system for facilitating funding of a financial account for a purchase transaction comprises a memory and a processing circuit coupled to the memory. The processing circuit is configured to receive a request to withdraw a first amount of currency from a first financial account as part of a purchase transaction, wherein the first financial account is a retail account that is subject to a first set of regulatory rules. The processing circuit is further configured to, in response to receiving the request, automatically transfer a second amount of currency from a second financial account to the first financial account, wherein the second financial account is a cashless wagering account that is subject to a second set of regulatory rules. The processing circuit is further configured to withdraw the first amount of currency from the first financial account as part of the purchase transaction.

According to another embodiment, automatically transferring the second amount of currency from a second financial account to the first financial account comprises in response to receiving the request to withdraw the first amount of currency from the first financial account, determining that the first financial account has a balance below the first amount of currency, and, in response to determining that the first financial account has a balance below the first amount of currency, transferring the second amount of currency from the second financial account to the first financial account so that the balance of the first financial account is above the first amount of currency.

According to another embodiment, automatically transferring the second amount of currency comprises selecting the second amount of currency so that transferring the second amount of currency to the first financial account and withdrawing the first amount of currency from the first financial account will result in the balance of the first financial account being no greater than a predetermined threshold amount.

According to another embodiment, the predetermined threshold amount is zero.

### BRIEF DESCRIPTION OF THE DRAWINGS

FIG. 1A is a diagram of a resort wallet system comprising a plurality of cashless wallets, including sports/mobile gaming wallet, a retail wallet, and a casino gaming wallet, according to an embodiment;

FIG. 1B is a diagram of a server system for managing and interacting with the resort wallet of FIG. 1, comprising a network-connected server, a plurality of gaming devices, a plurality of retail devices, and a plurality of mobile devices;

FIG. 2 is a communication diagram illustrating a process of funding a retail wallet using funds from a casino gaming wallet according to an embodiment;

FIG. 3 is a communication diagram illustrating a process of funding a retail wallet at least partially using funds from a casino gaming wallet according to an embodiment;

FIG. 4 is a communication diagram illustrating a process of creating a new retail wallet and funding the new retail wallet using funds from a casino gaming wallet according to an embodiment;

FIG. 5 is a communication diagram illustrating a process of reversing a purchase transaction made using a retail wallet by bypassing the retail wallet and transferring the refunded funds directly into a casino gaming wallet according to an embodiment;

FIG. 6 is a flowchart diagram of a method employing some of the features described herein, including features of the process of FIG. 2, according to an embodiment;

FIG. 7 is a flowchart diagram of a method employing some of the features described herein, including features of the process of FIG. 4, according to an embodiment;

FIG. 8 is a diagram of a processing system that may be used with embodiments described herein, according to an embodiment.

### DETAILED DESCRIPTION

Embodiments relate to cashless financial accounts and wallets, and in particular to a cashless retail wallet with just-in-time funding from a cashless wagering wallet, and related methods and systems. In this regard, in one embodiment, a server may receive a request to withdraw an amount of currency from a cashless retail wallet and/or other financial account as part of a purchase transaction, which is subject to a set of regulatory rules. In response to receiving the request, an amount of currency is transferred from a cashless wagering wallet and/or other financial account that is subject to a different set of regulatory rules into the cashless retail wallet, so that the cashless retail wallet has sufficient funds to complete the requested withdrawal. The funds are then withdrawn from the cashless retail wallet to complete the purchase transaction.

One advantage of this arrangement is that a cashless wagering wallet and a cashless retail wallet can be associated with a common resort wallet. The resort wallet can be used for gaming activity, in which case funds are withdrawn and deposited directly from the cashless wagering wallet, and for retail activity. For retail activity, the cashless retail wallet may be maintained at a low or zero-balance, and funded on a just-in-time basis from the cashless wagering wallet. When a user attempts to purchase a retail and/or service item using the resort wallet, the request on the cashless retail wallet causes sufficient funds to be transferred from the cashless wagering wallet into the cashless retail wallet to cover the request, thereby enabling the use of cashless wagering funds to be used for cashless retail wallet purchases. Because it may not be possible to withdraw funds from the cashless retail wallet directly, only the funds sufficient to cover the request are transferred into the cashless retail wallet, so that the ending balance for the cashless retail wallet remains at a low or zero balance after the purchase is complete. In this manner, a single resort wallet can be used to transparently provide access to a user's cashless wagering wallet and cashless retail wallet without requiring the user to separately track two different cashless wallet accounts, and while also respecting some of the pre-existing regulatory rules surrounding cashless retail wallets that exist in the United States and other jurisdictions.

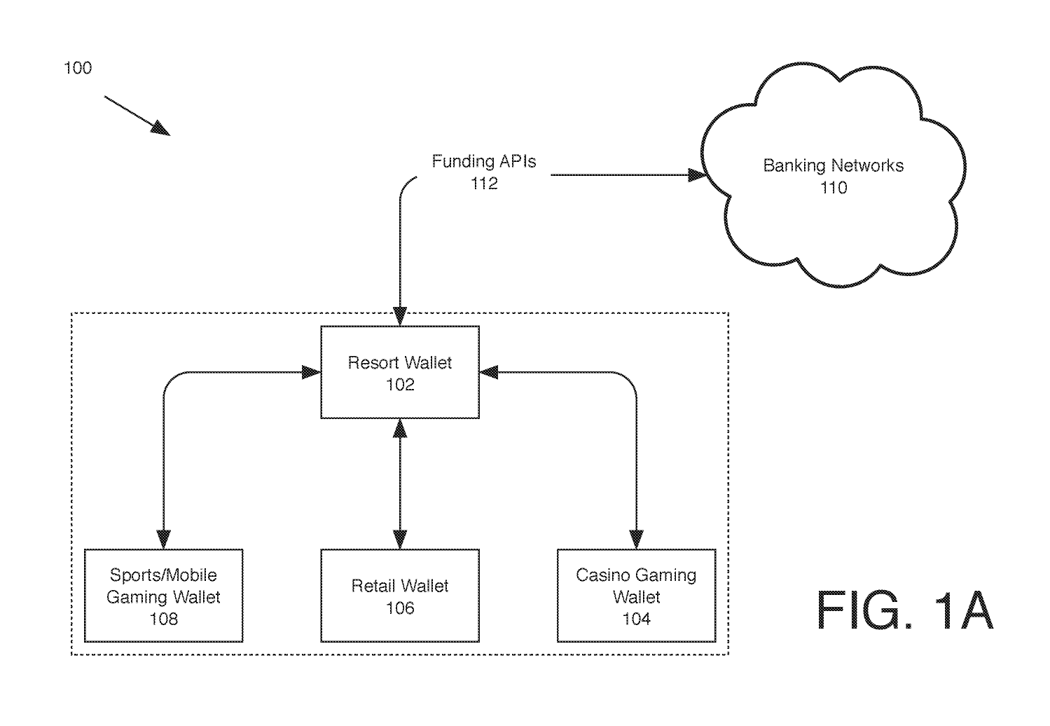

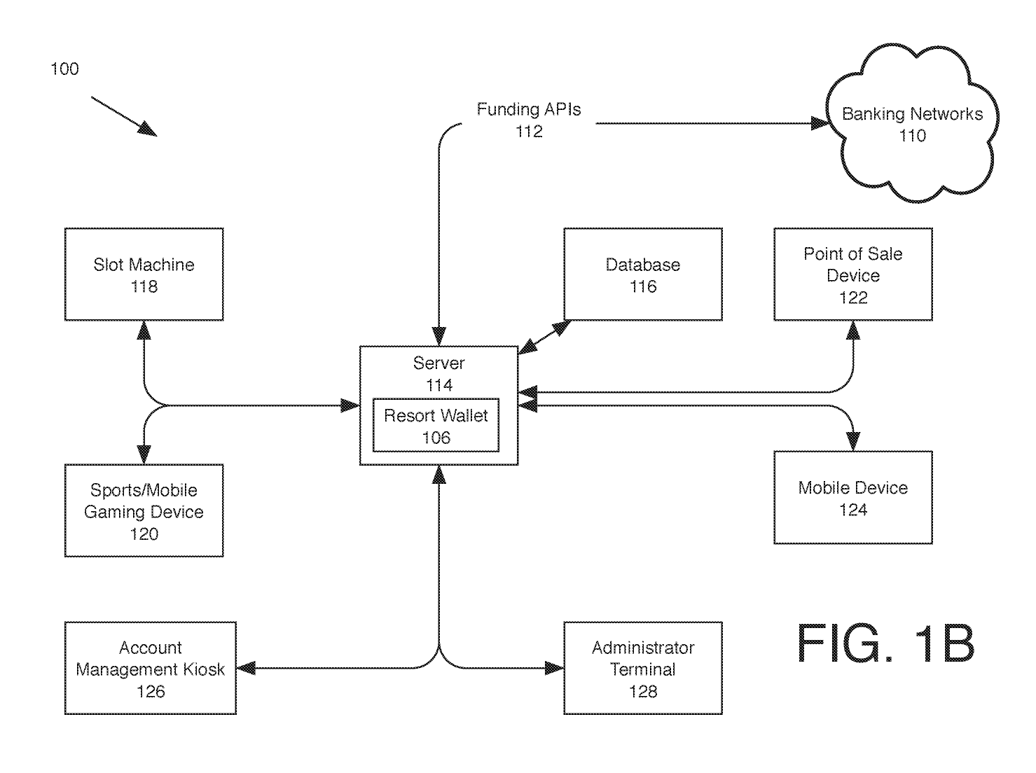

FIG. 1A is a diagram of a resort wallet system 100 comprising a plurality of cashless wallets, including sports/mobile gaming wallet, a retail wallet, and a casino gaming wallet, according to an embodiment. The resort wallet system 100, which may be embodied in hardware, software, or a combination thereof, includes a resort wallet 102 that serves as a combined wallet for a number of other cashless wallets and/or other financial accounts. In this example, the resort wallet 102 is linked with a casino gaming wallet 104, which is associated with a particular set of regulations, a retail wallet 106, which is associated with a different set of regulations, and a sport/mobile gaming wallet 108, which may be associated with another set of regulations as well. In this example, the resort wallet system 100 manages communication with one more banking networks 110 via one or more funding application programming interfaces (APIs) 112.

In one example, the resort wallet system 100 is embodied in a server-based system, such as the server 114 of FIG. 1B, coupled to a plurality of network-connected devices. In the example of FIG. 1B, the server 114 may be communicatively coupled to a database 116 directly and/or via a wired or wireless network, for example. The server 114 may also be communicatively coupled to a plurality of devices configured to interact with and/or manage certain aspects and/or features of the resort wallet system 100. For example, the server 114 may be coupled to one or more slot machines 118 and/or other gaming devices located on a casino floor. The slot machines 118 may be configured to access the casino gaming wallet 104 of a player for placing wagers for and paying out winnings to the player and may also be configured to access the retail wallet 106 for providing additional non-gaming features to the player. The server 114 may also be coupled to one or more mobile gaming devices 120 configured to facilitate a player making sports and/or other wagers with funds from an associated sports/mobile gaming wallet 108.

The server 114 may also be coupled to one or more point of sale devices 122, such as a checkout register and/or retail kiosk. The point of sale devices 122 may be configured to access the retail wallet 106 of the player for facilitating purchases and/or other retail transactions for the player. The server 114 may also be coupled to a player's own personal mobile device 124, such as a mobile phone and/or tablet, for example. The personal mobile device 124 may include hardware and/or software for accessing one or more of the wallets associated with the resort wallet system 100 and facilitating associated gaming and/or retail activity by the player via the mobile device 124.

The server 114 may also be coupled to one or more account management kiosks 126 for allowing a player to access and manage one or more of the accounts associated with the resort wallet system 100. The server 114 may also be coupled to one or more administrator terminals 128 for allowing an administrator and/or other authorized third party to access and manage one or more accounts associated with a player's resort wallet system 100.

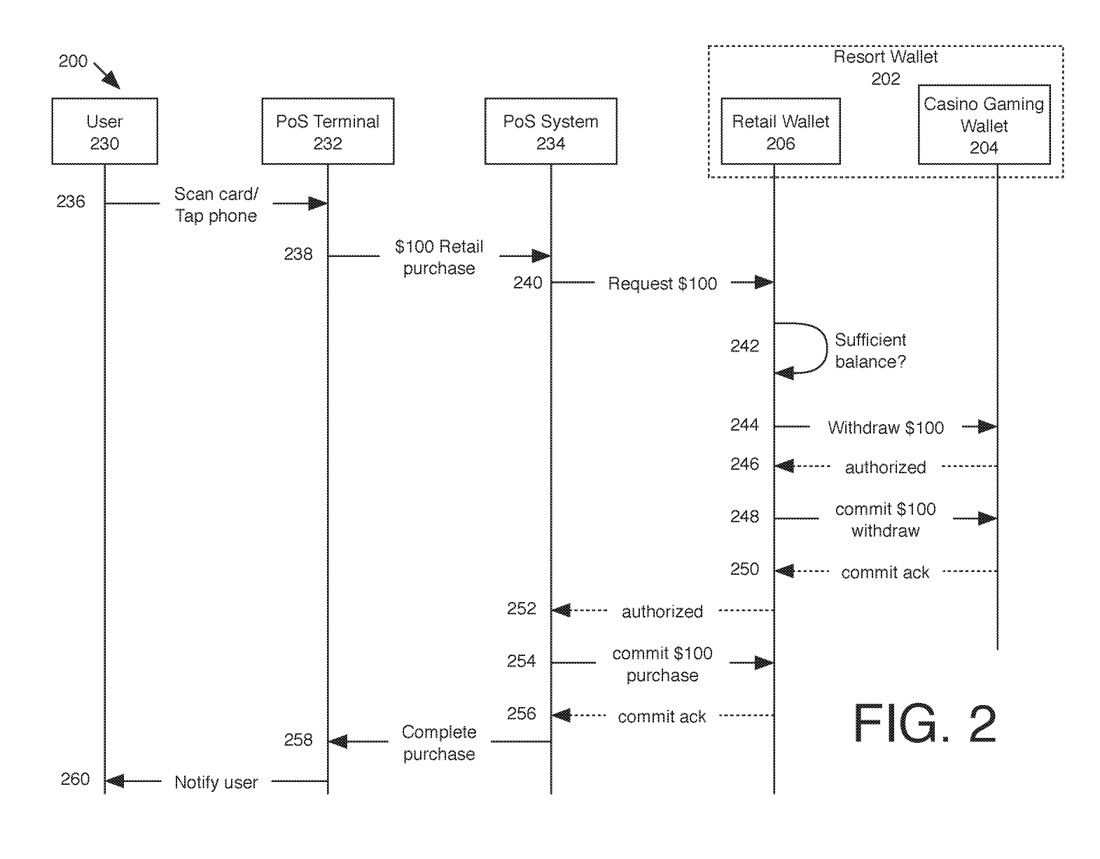

FIG. 2 is a communication diagram illustrating a process 200 of funding a retail wallet 206 using funds from a casino gaming wallet 204 according to an embodiment. In this example, the retail wallet 206 and the casino gaming wallet 204 are part of a unified resort wallet 202 that facilitates communication between the retail wallet 206 and the casino gaming wallet 204. According to the process 200 of FIG. 2, a user 230 initiates a purchase transaction at a point of sale (PoS) terminal 232 coupled to a PoS system 234, for example by scanning and/or swiping a card and/or mobile device at the PoS terminal 232 (step 236). The PoS terminal 232 initiates a retail purchase transaction (for $100 in this example) with the PoS system 234 (step 238), which in turn requests the $100 in funds from the retail wallet 206 associated with the user 230 (step 240). If it is determined that the retail wallet 206 has an insufficient balance to complete the purchase (step 242), the retail wallet 206 and the casino gaming wallet 204 perform a two-phase transaction: In phase 1, the retail wallet sends an originating request to withdraw the $100 in funds from the casino gaming wallet 204 (step 244), and the casino gaming wallet 204 performs an authorization request/response pair (step 246) with the retail wallet 206. In phase 2, the retail wallet 206 committing to the $100 withdrawal (step 248), and the casino gaming wallet 204 performs a commit ack request and response pair with the retail wallet 206 (step 250) to complete the transfer of the funds from the casino gaming wallet 204 to the retail wallet 206. It should be understood, however, that in this and other embodiments, different protocols may be used, as desired. For example, in some embodiments, a single-phase transaction having a single request and response pair may be used.

Next, the retail wallet 206 and the PoS system 234 perform another two-phase transaction that includes the retail wallet 206 performing an authorization request/response pair (step 252) with the PoS system 234, and the PoS system 234 committing to the $100 purchase (step 254), and performing a commit ack request and response pair with the retail wallet 206 (step 256). The PoS system 234 next instructs the PoS terminal 232 to complete the purchase (step 258) and the PoS terminal 232 notifies the user 230 that the purchase is complete (step 260).

This arrangement allows the balance of the retail wallet 206 to be maintained at or below a predetermined threshold amount following the purchase transaction, i.e., so that completing the purchase transaction results in the balance of the retail wallet 206 being no greater than a predetermined threshold amount. In this example, the predetermined threshold amount is zero, so as to ensure that no funds are transferred into the retail wallet 206 except in connection with a pending purchase. This prevents funds from being “trapped” in the retail wallet 206, where they are unavailable for non-retail use. Meanwhile, a combined balance equal to at least a sum of the balance of the retail account 206 and the balance of the cashless wagering account 204 may be provided to the user 230 to provide an indication of the total amount of funds available to the user 230 for both retail and wagering purposes. In some embodiments, the individual balances of the retail account 206 and the cashless wagering account 204 may also be concealed from the user 230 so as to avoid confusion or complexity for the user 230.

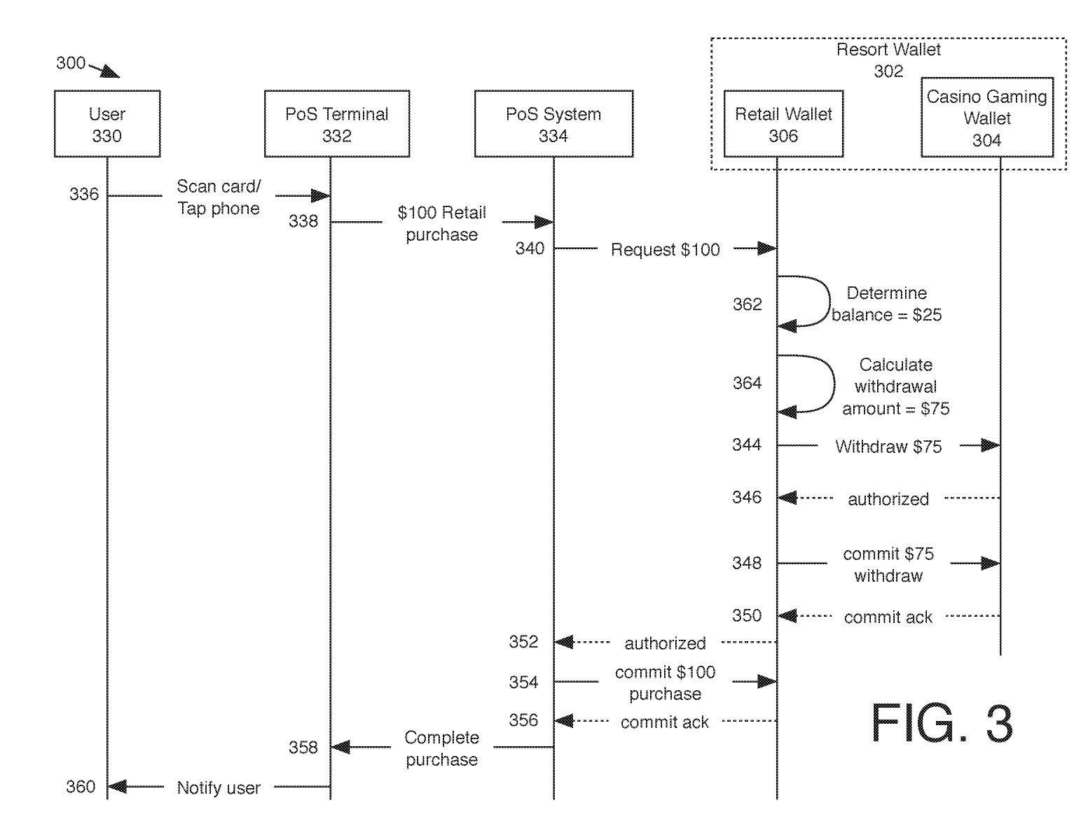

In some embodiments, the retail account may have sufficient funds to cover part of the requested withdrawal, making it unnecessary to transfer the entire amount required for the purchase into the retail account. In this regard, FIG. 3 is a communication diagram illustrating a process 300 of funding a retail wallet 306 at least partially using funds from a casino gaming wallet 304 according to an embodiment.

In the process 300 of FIG. 3, the retail wallet 306 and the casino gaming wallet 304 are part of a unified resort wallet 302, similar to the resort wallet 202 of FIG. 2. According to the process 300 of FIG. 3, a user 330, similar to the user 230 of FIG. 2, initiates a purchase transaction at a point of sale (PoS) terminal 332 coupled to a PoS system 334, for example by scanning and/or swiping a card and/or mobile device at the PoS terminal 332 (step 336). The PoS terminal 332 initiates a retail purchase transaction (for $100 in this example) with the PoS system 334 (step 338), which in turn requests the $100 in funds from the retail wallet 306 associated with the user 330 (step 340).

In this example, the balance of the retail wallet 306 is determined to be $25 (step 362), which is insufficient to cover the $100 purchase. A withdrawal amount is calculated (step 364) based on the difference between the purchase price ($100) and the current balance ($25) in the retail wallet 206. The retail wallet 306 requests to withdraw the calculated $75 in funds from the casino gaming wallet 304 (step 344). The retail wallet 306 and the casino gaming wallet 304 perform a two-phase transaction (steps 346-350), similar to the two-phase transaction (steps 246-250) of FIG. 2, to complete the transfer of the funds from the casino gaming wallet 304 to the retail wallet 306.

Next, the retail wallet 306 and the PoS system 334 of FIG. 3 perform another two-phase transaction (steps 352-356), similar to the two-phase transaction (steps 252-256) of FIG. 2. The PoS system 334 next instructs the PoS terminal 332 to complete the purchase (step 358) and the PoS terminal 232 notifies the user 230 that the purchase is complete (step 360).

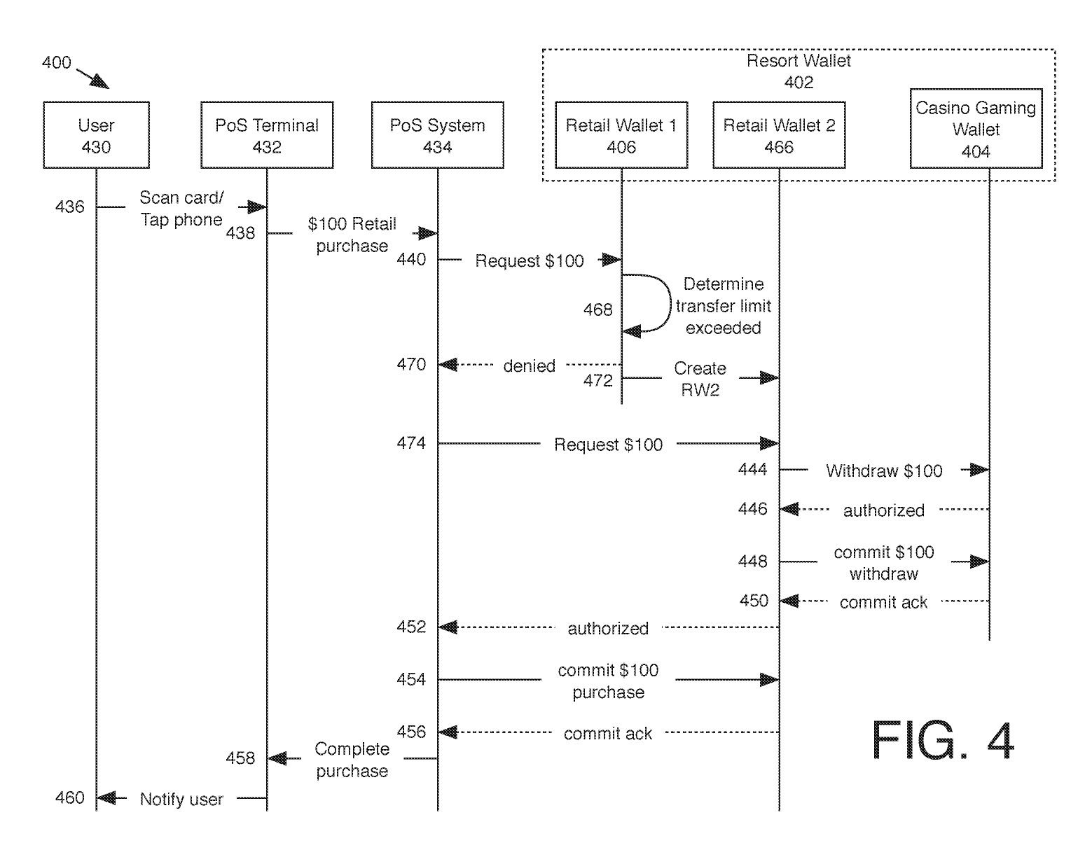

In some embodiments, regulations may prohibit transfers of funds into a retail wallet beyond a predetermined threshold, such as a predetermined maximum number of transfers and/or a predetermined maximum amount of funds. To address these potential limitations, a new second retail wallet may be created in real time in the event that a first retail wallet is unable to receive the necessary funds to complete a purchase. In this regard, FIG. 4 is a communication diagram illustrating a process 400 of creating a new second retail wallet 466 and funding the new second retail wallet 466 using funds from a casino gaming wallet 404 according to an embodiment.

In the process 400 of FIG. 4, a first retail wallet 406 and the casino gaming wallet 404 are part of a unified resort wallet 402, similar to the resort wallet 202 of FIG. 2. According to the process 400 of FIG. 4, a user 430, similar to the user 230 of FIG. 2, initiates a purchase transaction at a point of sale (PoS) terminal 432 coupled to a PoS system 434, for example by scanning and/or swiping a card and/or mobile device at the PoS terminal 432 (step 436). The PoS terminal 432 initiates a retail purchase transaction (for $100 in this example) with the PoS system 434 (step 438), which in turn requests the $100 in funds from the first retail wallet 406 associated with the user 430 (step 440).

In this example, it is determined that a maximum transfer limit has been reached or exceeded (step 468), and in response, the first retail wallet 406 denies the request (step 470) and creates a new second retail wallet 466. The PoS system 434 sends a new request (step 474) to the second retail wallet 466, and the second retail wallet 466 requests to withdraw $100 in in funds from the casino gaming wallet 404 (step 444). The second retail wallet 466 and the casino gaming wallet 404 perform a two-phase transaction (steps 446-450), similar to the two-phase transaction (steps 246-250) of FIG. 2, to complete the transfer of the funds from the casino gaming wallet 404 to the second retail wallet 466, and the second retail wallet 466 and the PoS system 434 of FIG. 4 perform another two-phase transaction (steps 452-456), similar to the two-phase transaction (steps 252-256) of FIG. 2. The PoS system 434 next instructs the PoS terminal 432 to complete the purchase (step 458) and the PoS terminal 432 notifies the user 430 that the purchase is complete (step 460).

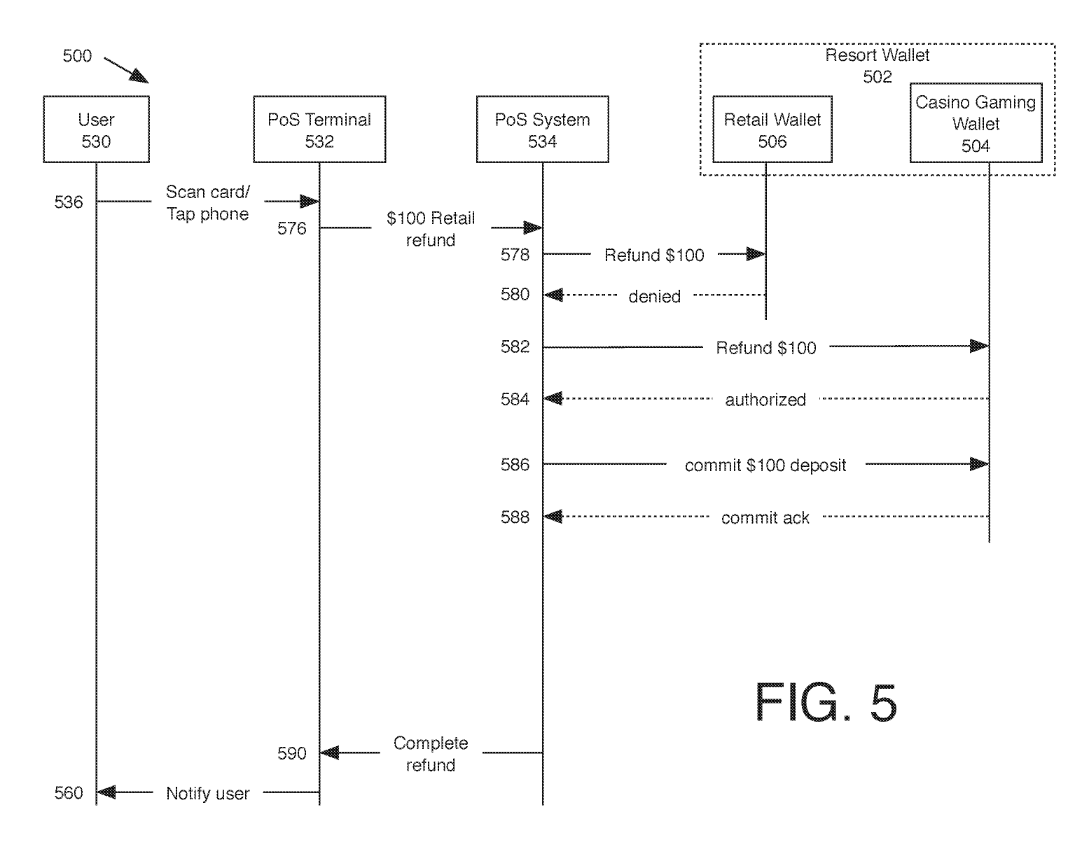

In some embodiments, it may be necessary to reverse and/or refund a purchase transaction. However, refunding purchase funds directly into a retail wallet may make those funds unavailable for other purposes, such as for wagering and/or gaming activity, because regulations may prohibit transfers of funds out of the retail wallet if the transfer is not part of a retail purchase into a retail wallet. To address these potential limitations, a reversal and/or refund transaction may bypass the retail wallet that was used in the original purchase. In this regard, FIG. 5 is a communication diagram illustrating a process 500 of reversing a purchase transaction made using a retail wallet 506 by bypassing the retail wallet 506 and transferring the refunded funds directly into a casino gaming wallet 504 according to an embodiment.

In the process 500 of FIG. 5, the retail wallet 506 and the casino gaming wallet 504 are part of a unified resort wallet 502, similar to the resort wallet 202 of FIG. 2. According to the process 500 of FIG. 5, a user 530, similar to the user 230 of FIG. 2, initiates a refund transaction at a point of sale (PoS) terminal 532 coupled to a PoS system 534, for example by scanning and/or swiping a card and/or mobile device at the PoS terminal 532 (step 536). The PoS terminal 532 initiates a retail refund transaction (for $100 in this example) with the PoS system 534 (step 576), which in turn communicates with the retail wallet 506 to attempt to deposit the $100 in funds into the retail wallet 506 (step 578).

In this example, the retail wallet 506 denies the request (step 580), and may include an instruction as part of the denial message that causes the PoS system 534 to next attempt to deposit the $100 in funds into the casino gaming wallet 504 (step 582). Next, the casino gaming wallet 504 and the PoS system 534 perform a two-phase transaction that includes the casino gaming wallet 504 performing an authorization request/response pair (step 584) with the PoS system 534, and the PoS system 534 committing to the $100 deposit (step 586), and performing a commit ack request and response pair with the PoS system 534 (step 588). The PoS system 534 next instructs the PoS terminal 532 to complete the refund (step 590) and the PoS terminal 532 notifies the user 530 that the refund is complete (step 560).

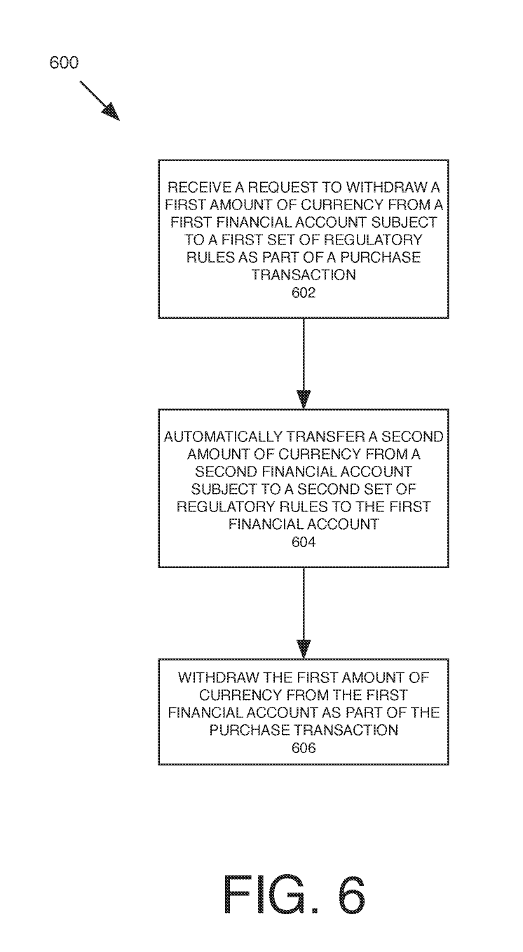

As discussed above, the above features may be embodied in a number of different processes. In this regard, FIG. 6 is a flowchart diagram of a method 600 employing some of the features described above, including features of the process 200 of FIG. 2 for example. The method 600 includes receiving, at a server comprising a processing device, a request to withdraw a first amount of currency from a first financial account as part of a purchase transaction, wherein the first financial account is a retail account that is subject to a first set of regulatory rules (block 602). The method 600 further includes, in response to receiving the request, automatically transferring a second amount of currency from a second financial account to the first financial account, wherein the second financial account is a cashless wagering account that is subject to a second set of regulatory rules (block 604). The method 600 further comprises withdrawing the first amount of currency from the first financial account as part of the purchase transaction (block 606).

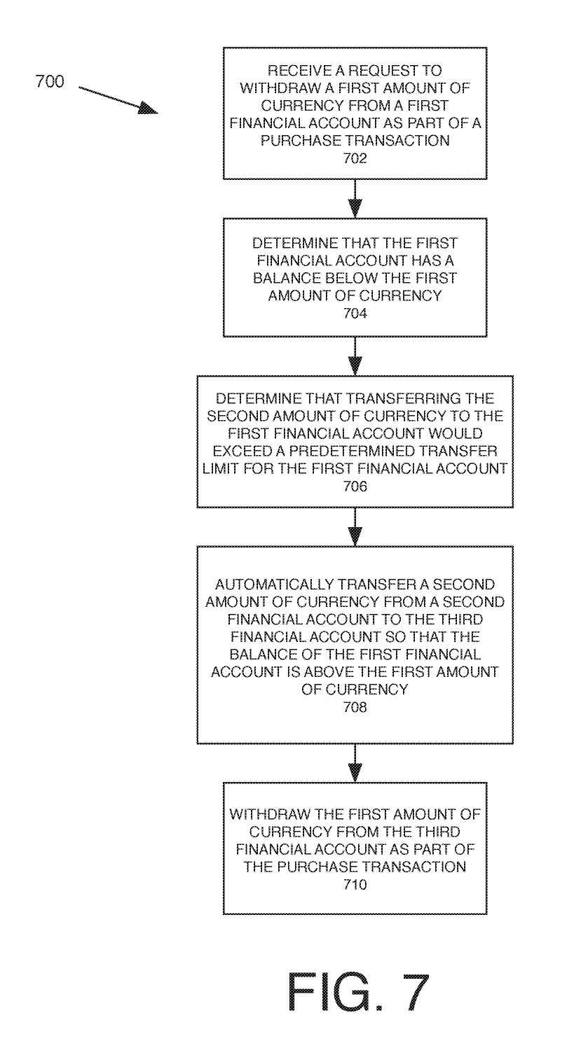

In another example, FIG. 7 is a flowchart diagram of another method 700 employing some of the features described above, including features of the process 400 of FIG. 4, for example. The method 700 includes receiving, at a server comprising a processing device, a request to withdraw a first amount of currency from a first financial account as part of a purchase transaction (block 702). The method 700 further includes, in response to receiving the request, determining that the first financial account has a balance below the first amount of currency (block 704). The method 700 further includes determining that transferring the second amount of currency to the first financial account would exceed a predetermined transfer limit for the first financial account (block 706). The method 700 further includes, in response to determining that transferring the second amount of currency to the first financial account would violate a predetermined rule for the first financial account, automatically transferring a second amount of currency from a second financial account to the third financial account so that the balance of the first financial account is above the first amount of currency (block 708). The method further includes withdrawing the first amount of currency from the third financial account as part of the purchase transaction (block 710).

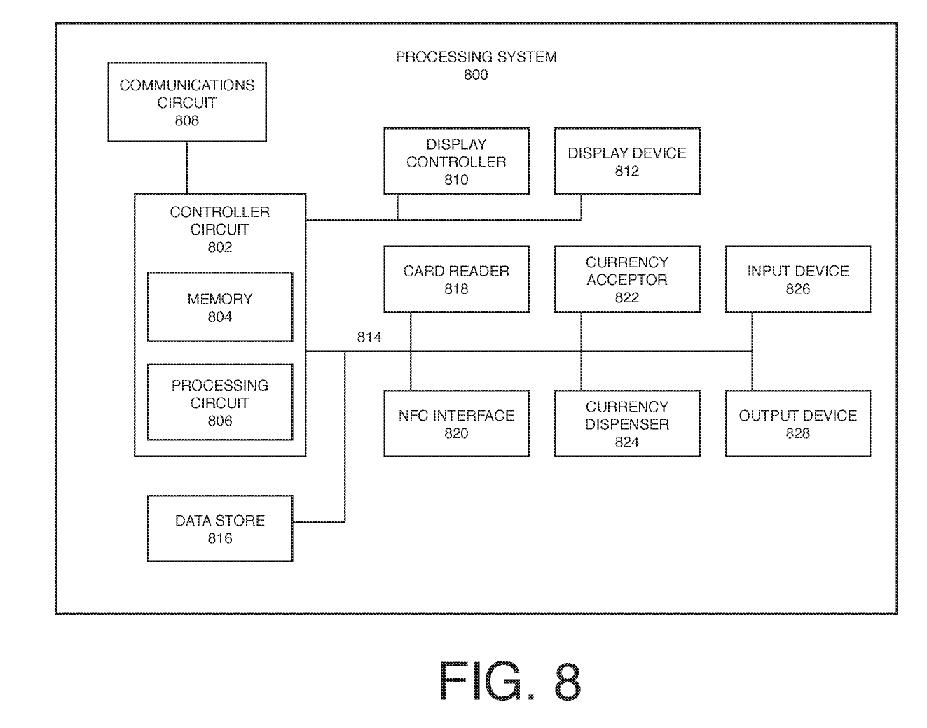

As discussed above, the above features may be embodied in hardware, software, or a combination thereof. In this regard, FIG. 8 is a diagram of a processing system 800 that may be used with embodiments described herein, according to an embodiment. The processing system 800 includes a controller circuit 802 having a memory 804 and a processor circuit 806. A communications circuit 808 may contain circuitry for coupling the processing system 800 to network. The communications circuit 808 may include a network interface allowing processing system 800 to communicate with other components, to access and connect to network resources, to serve an application, to access other applications, and to perform other computing applications by connecting to a network (or multiple networks) capable of carrying data including the Internet, Ethernet, plain old telephone service (POTS) line, public switch telephone network (PSTN), integrated services digital network (ISDN), digital subscriber line (DSL), coaxial cable, fiber optics, satellite, mobile, wireless (e.g. WMAX), SS7 signaling network, fixed line, local area network, wide area network, and others, including any combination of these. The processing system 800 may communicate over a network using a suitable protocol.

The communications circuit 808 may communicate, transmit and receive data using a wireless transmitter, and/or it may be wired to a network, such as a local area network running throughout the casino floor, for example. The communications circuit 808 may set up a communication link with a master controller and may buffer data between the network and the controller circuit 802. The communications circuit 808 may also communicate with a network server for exchanging information to carry out embodiments described herein.

The controller circuit 802 includes a memory 804 and a processor circuit 806 for carrying out program instructions stored in the memory and for providing the information requested by the network. The processor circuit 806 may be a multi-core processor including two or more independent processing units. Each of the cores in the processor circuit 806 may support multi-threading operations, i.e., may have the capability to execute multiple processes and/or threads concurrently. Additionally, the processor circuit 806 may have an on-board memory cache. An example of a suitable multi-core, multithreaded processor circuit is an Intel® Core i7-7920HQ processor, which has four cores that support eight threads each and has an 8 MB on-board cache. The controller circuit 802 executes processes and cooperates with a display controller 810 to control one or more of display device 812 to display a viewing area and provide information to a user.

Peripheral devices/boards in the processing system 800 may communicate with the controller circuit 802 via a bus 814 using, for example, an RS-232 interface. Such peripherals may include an electronic data store 816, which may, for example, include a set of machine readable instructions for performing some or all of the features of the processes and methods disclosed herein. The electronic data store 816 may reside in a data storage device, e.g., a hard disk drive, a solid-state drive, or the like. Such a data storage device may be included in processing device, and/or may reside on a remote system. In some embodiments, the electronic data store storing game data may reside in the cloud.

Other peripherals may include a smart card reader and/or other type of credit card reader 818, a near field communication (NFC) and/or other wireless interface, a bill, coin, and/or other currency acceptor 822, a bill, coin, and/or other currency dispenser 824, and/or other input devices 826 and output devices 828, such as buttons, a touch screen, gesture tracking hardware, audio speakers, and/or microphones, for example.

The card reader 818 reads cards for player and credit information for one or more aspects of the cashless wallets described herein. For example, the card reader 818 may read a magnetic code on a conventional player tracking card, where the code uniquely identifies the player to a host system at the venue. The code is cross-referenced to any data related to the player. The card reader 818 may also include an optical reader and printer for reading and printing coded barcodes and other information on a paper ticket. A card may also include credentials that enable the processing system 800 and/or network-connected host system to access one or more accounts associated with a user.

In the above-description of various embodiments, various aspects may be illustrated and described herein in any of a number of patentable classes or contexts including any new and useful process, machine, manufacture, or composition of matter, or any new and useful improvement thereof. Accordingly, various embodiments described herein may be implemented entirely by hardware, entirely by software (including firmware, resident software, micro-code, etc.) or by combining software and hardware implementation that may all generally be referred to herein as a “circuit,” “module,” “component,” or “system.” Furthermore, various embodiments described herein may take the form of a computer program product comprising one or more computer readable media having computer readable program code embodied thereon.

Any combination of one or more computer readable media may be used. The computer readable media may be a computer readable signal medium or a non-transitory computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random-access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible non-transitory medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Various embodiments were described herein with reference to flowchart illustrations and/or block diagrams of methods, apparatus (systems), devices and computer program products according to various embodiments described herein. It will be understood that each block of the flowchart illustrations and/or block diagrams, and combinations of blocks in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a non-transitory computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods, and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprise” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be designated as “/”. Like reference numbers signify like elements throughout the description of the figures.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

1. A method comprising:
receiving, at a server comprising a processing device, a request to withdraw a first amount of currency from a first financial account as part of a purchase transaction, wherein the first financial account is a retail account that is subject to a first set of regulatory rules;
in response to receiving the request, automatically transferring a second amount of currency from a second financial account to the first financial account, wherein the second financial account is a cashless wagering account that is subject to a second set of regulatory rules; and
withdrawing the first amount of currency from the first financial account as part of the purchase transaction.

2. The method of claim 1, wherein automatically transferring the second amount of currency from a second financial account to the first financial account comprises:
in response to receiving the request to withdraw the first amount of currency from the first financial account, determining that the first financial account has a balance below the first amount of currency; and
in response to determining that the first financial account has a balance below the first amount of currency, transferring the second amount of currency from the second financial account to the first financial account so that the balance of the first financial account is above the first amount of currency.

3. The method of claim 1, wherein automatically transferring the second amount of currency comprises selecting the second amount of currency so that transferring the second amount of currency to the first financial account and withdrawing the first amount of currency from the first financial account will result in the balance of the first financial account being no greater than a predetermined threshold amount.

4. The method of claim 3, wherein the predetermined threshold amount is zero.

5. The method of claim 1, further comprising displaying a combined balance to a user, wherein the combined balance is equal to at least a sum of the balance of the first financial account and the balance of the second financial account.

6. The method of claim 5, wherein displaying the combined balance to the user comprises concealing the balance of the first financial account and the balance of the second financial account from the user.

7. The method of claim 1, further comprising:
prior to receiving the request to withdraw the first amount of currency from the first financial account, receiving a request to withdraw the first amount of currency from a third financial account as part of the purchase transaction, wherein the third financial account is a retail account that is subject to the first set of regulatory rules;
determining that transferring the second amount of currency from the second financial account to the third financial account would violate at least one regulatory rule of the first set of regulatory rules; and
denying the request to withdraw the first amount of currency from the third financial account.

8. The method of claim 7, further comprising, prior to receiving the request to withdraw the first amount of currency from the first financial account, automatically creating the first financial account in response to determining that transferring the second amount of currency from the second financial account to the third financial account would violate at least one regulatory rule of the first set of regulatory rules.

9. The method of claim 7, wherein determining that transferring the second amount of currency from the second financial account to the third financial account would violate at least one regulatory rule of the first set of regulatory rules comprises determining that transferring the second amount of currency from the second financial account to the third financial account would exceed a predetermined number of transfers for the third financial account.

10. The method of claim 1, further comprising:
receiving, at a server comprising a processing device, a request to deposit a first amount of currency to a first financial account as part of a reversal of the purchase transaction; and
in response to receiving the request, automatically transferring the first amount of currency to a second financial account.

11. The method of claim 10, wherein automatically transferring the first amount of currency to the second financial account comprises:
determining that the previous purchase transaction included transferring the second amount of currency from the second financial account to the first financial account; and
transferring the first amount of currency to the second financial account.

12. A method comprising:
receiving, at a server comprising a processing device, a request to withdraw a first amount of currency from a first financial account as part of a purchase transaction;
in response to receiving the request, determining that the first financial account has a balance below the first amount of currency;
determining that transferring the second amount of currency to the first financial account would exceed a predetermined transfer limit for the first financial account; and
in response to determining that transferring the second amount of currency to the first financial account would violate a predetermined rule for the first financial account, automatically transferring a second amount of currency from a second financial account to a third financial account so that the balance of the third financial account is above the first amount of currency; and
withdrawing the first amount of currency from the third financial account as part of the purchase transaction.

13. The method of claim 12, further comprising, in response to determining that transferring the second amount of currency to the first financial account would violate a predetermined rule for the first financial account, automatically creating a third financial account.

14. The method of claim 12, wherein determining that transferring the second amount of currency from the second financial account to the first financial account would violate the predetermined rule for the first financial account comprises determining that transferring the second amount of currency from the second financial account to the first financial account would exceed a predetermined number of transfers for the first financial account.

15. The method of claim 12, wherein the first financial account and the third financial account are retail accounts subject to a first set of regulatory rules.

16. The method of claim 15, wherein the second account is a cashless wagering account that is subject to a second set of regulatory rules different from the first set of regulatory rules.

17. A system for facilitating funding of a financial account for a purchase transaction comprising:
a memory; and
a processing circuit coupled to the memory, the processing circuit configured to:
receive a request to withdraw a first amount of currency from a first financial account as part of a purchase transaction, wherein the first financial account is a retail account that is subject to a first set of regulatory rules;
in response to receiving the request, automatically transfer a second amount of currency from a second financial account to the first financial account, wherein the second financial account is a cashless wagering account that is subject to a second set of regulatory rules; and
withdraw the first amount of currency from the first financial account as part of the purchase transaction.

18. The system of claim 17, wherein automatically transferring the second amount of currency from a second financial account to the first financial account comprises:
in response to receiving the request to withdraw the first amount of currency from the first financial account, determining that the first financial account has a balance below the first amount of currency; and
in response to determining that the first financial account has a balance below the first amount of currency, transferring the second amount of currency from the second financial account to the first financial account so that the balance of the first financial account is above the first amount of currency.

19. The system of claim 17, wherein automatically transferring the second amount of currency comprises selecting the second amount of currency so that transferring the second amount of currency to the first financial account and withdrawing the first amount of currency from the first financial account will result in the balance of the first financial account being no greater than a predetermined threshold amount.

20. The system of claim 19, wherein the predetermined threshold amount is zero.
